(19) United States
(12) Patent Application Publication
(10) Pub. No.: US 2022/0328047 A1
(43) Pub. Date: Oct. 13, 2022

(54) SPEECH RECOGNITION CONTROL APPARATUS, SPEECH RECOGNITION CONTROL METHOD, AND PROGRAM

(71) Applicant: NIPPON TELEGRAPH AND TELEPHONE CORPORATION, Tokyo (JP)

(72) Inventors: Takaaki FUKUTOMI, Tokyo (JP); Yoshikazu YAMAGUCHI, Tokyo (JP); Yusuke SHINOHARA, Tokyo (JP); Kiyoaki MATSUI, Tokyo (JP); Takafumi MORIYA, Tokyo (JP)

(73) Assignee: NIPPON TELEGRAPH AND TELEPHONE CORPORATION, Tokyo (JP)

(21) Appl. No.: 17/615,812

(22) PCT Filed: Jun. 4, 2019
(86) PCT No.: PCT/JP2019/022163

§ 371 Date: Dec. 1, 2021

(51) Int. Cl. G10L 15/32; G10L 15/30; G10L 15/22

(52) U.S. Cl. CPC G10L 15/32; G10L 15/30; G10L 15/22

(57) ABSTRACT

Recognition results are acquired with high responsiveness without being affected by a network communication state. A speech recognition control device (1) acquires recognition results from a speech recognition device (2) with which it communicates through a network (3) and a speech recognition unit (13). A communication state measuring unit (11) measures a communication state of the network (3). A speech recognition requesting unit (12) transmits a request for a speech recognition process to each of the speech recognition device (2) and the speech recognition unit (13) with a timeout time set in accordance with an immediately prior communication state of the network (3). A recognition result output unit (14) outputs a recognition result based on a recognition result received from one or recognition results received from both of the speech recognition device (2) and the speech recognition unit (13).

### TECHNICAL FIELD

The present invention relates to a speech recognition technology, and more particularly, to a technology for controlling outputs of a plurality of speech recognizers through a network.

### BACKGROUND ART

In systems that provide speech recognition, there is a scheme in which speech recognizers are deployed on both a user terminal side and a cloud side, and a recognition result is returned with high accuracy and high responsiveness by performing a threshold process using a reliability scale of the speech recognition result and a timeout process for a time required until acquisition of the recognition result. For example, there is a method in which, in a case where a reliability scale of a speech recognition result that has been acquired first out of recognition results of the user terminal side and the cloud side exceeds a threshold, only the acquired recognition result is returned without waiting for the acquisition of the other recognition results. In addition, there is a method in which waiting for recognition results of the user terminal side and the cloud side is performed until a designated timeout time, recognition results are integrated and returned, for example, using a technology disclosed in Non Patent Literature 1 or the like in a case where both the results have been acquired, and only an acquired result is returned in a case where only one result has been acquired.

### CITATION LIST

### Non Patent Literature

Non Patent Literature 1: Fiscus, J. G., “A Post-Processing System to Yield Reduced Word Error Rates; Recognizer Output Voting Error Reduction (ROVER)”, Proceedings of IEEE Workshop on Automatic Speech Recognition and Understanding, pp. 347-354, 1997.

### SUMMARY OF THE INVENTION

### Technical Problem

However, in the related art, a timeout time used for waiting for a recognition result is fixedly set, and it is necessary to wait until the timeout time expires even in a case where it is clear that another result cannot be acquired within the timeout time such as when the network is congested or the like.

An object of the present invention is, in view of the technical problems described above, to provide a speech recognition technology capable of acquiring a recognition result with high responsiveness without being affected by a network communication state.

### Means for Solving the Problem

In order to solve the problems described above, a speech recognition control device according to one aspect of the present invention is a speech recognition control device that acquires recognition results from a plurality of speech recognizers including at least one speech recognizer that performs communication through a network and includes a communication state measuring unit configured to measure a communication state of the network, a speech recognition requesting unit configured to transmit a request for a speech recognition process to each of the plurality of speech recognizers with a timeout time set in accordance with an immediately prior communication state of the network, and a recognition result output unit configured to output a recognition result based on a recognition result received from at least one of the plurality of speech recognizers.

### Effects of the Invention

According to the present invention, a timeout process for waiting for a recognition result can be performed in accordance with a network communication state that changes from moment to moment, and thus responsiveness until the acquisition of a recognition result is improved.

### BRIEF DESCRIPTION OF DRAWINGS

FIG. 1 is a diagram illustrating the functional configuration of a speech recognition control device.

FIG. 2 is a diagram illustrating a processing sequence of a speech recognition control method.

FIG. 3 is a diagram illustrating the functional configuration of a computer.

### DESCRIPTION OF EMBODIMENTS

Hereinafter, an embodiment of the present invention will be described in detail. In the drawings, the same reference numerals are given to constituent units that have the same functions and repeated description will be omitted.

### First Embodiment

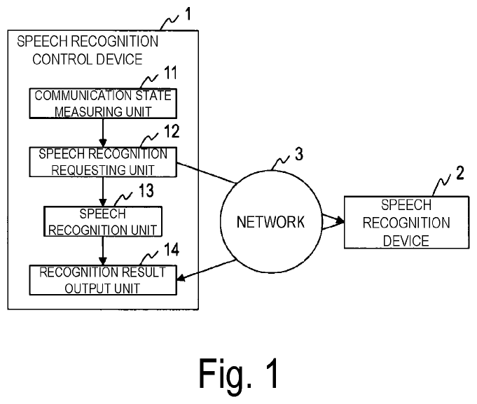

As illustrated in FIG. 1, a speech recognition control device 1 according to a first embodiment includes, for example, a communication state measuring unit 11, a speech recognition requesting unit 12, a speech recognition unit 13, and a recognition result output unit 14. The speech recognition control device 1 is connected to a network 3 so as to be able to communicate with at least one speech recognition device 2. The network 3 is a circuit-switched or packet-switched communication network configured to enable connected devices to communicate with each other, and, for example, the Internet, a local area network (LAN), a wide area network (WAN), or the like can be used. In FIG. 1, although a configuration using two speech recognizers including the speech recognition unit 13, which can be used without going through the network 3, and the speech recognition device 2, which performs communication through the network 3, is employed, a configuration using three or more speech recognizers including the speech recognition unit 13 and two or more speech recognition devices 2 or a configuration using two or more speech recognizers including two or more speech recognition devices 2 without including the speech recognition unit 13 may be employed. In other words, the number and positions of speech recognizers are not limited as long as at least one of a plurality of the speech recognizers can be used through the network 3. When processes of steps to be described below are performed by the speech recognition control device 1, a speech recognition control method according to the first embodiment is realized.

For example, the speech recognition control device 1 is a special device configured by reading a special program into a known or dedicated computer that includes a central arithmetic processing device (a central processing unit (CPU)), a main storage device (a random access memory (RAM)), and the like. The speech recognition control device 1, for example, executes each process under the control of the central arithmetic processing device. Data input to the speech recognition control device 1 and data acquired in each process are stored, for example, in the main storage device, and the data stored in the main storage device is read out to the central arithmetic processing device as necessary and is used for other processes. At least some processing units of the speech recognition control device 1 may be configured by hardware such as integrated circuits and the like.

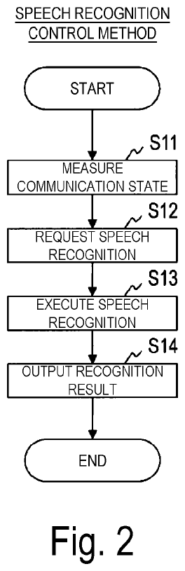

A processing procedure of the speech recognition control method executed by the speech recognition control device 1 according to the first embodiment will be described with reference to FIG. 2.

In step S11, the communication state measuring unit 11 of the speech recognition control device 1 measures a communication state of the network 3 until a speech recognition process is started. The communication state is measured using a scale such as round trip time (RTT). For example, an average value of round trip times for N seconds immediately prior to the start of a speech recognition process is used. For example, N may be set to about 3 seconds.

In step S12, the speech recognition requesting unit 12 of the speech recognition control device 1 transmits a request for a speech recognition process to each of the speech recognition unit 13 and the speech recognition device 2. At this time, a timeout time until both recognition results of both sides can be acquired (in other words, waiting for both recognition results) is set in accordance with a prior communication state measured by the communication state measuring unit 11. When an immediately prior round trip time before execution of speech recognition is RTT_b, an average value of the round trip time at the time of non-network congestion is RTT_ave, and a standard deviation of the round trip time at the time of non-network congestion is RTT_sd, the speech recognition requesting unit 12 performs control in which a waiting process is not performed at the time of network congestion in which RTT_b>RTT_ave+2*RTT_sd. In addition, at a normal time in which RTT_b≤RTT_ave+2*RTT_sd, the speech recognition requesting unit 12 performs control in which a process of waiting for recognition results is performed using a defined timeout time T_th as is.

In step S13, each of the speech recognition unit 13 of the speech recognition control device 1 and the speech recognition device 2 executes a speech recognition process in response to the request for a speech recognition process received from the speech recognition requesting unit 12 and transmits a recognition result to the recognition result output unit 14 of the speech recognition control device 1.

In step S14, the recognition result output unit 14 of the speech recognition control device 1 determines and outputs recognition results of the speech recognition processes based on the recognition results acquired from the speech recognition unit 13 and the speech recognition device 2. In a case where the speech recognition requesting unit 12 performs control in which a waiting process is not performed, the recognition result output unit 14 determines a recognition result that is acquired first as the recognition result of the speech recognition process. In a case where the speech recognition requesting unit 12 performs a waiting process with the timeout time T_th set, the recognition result output unit 14 determines a recognition result of the speech recognition process based on one or more recognition results acquired within the timeout time T_th. For example, in a case where there is one recognition result that has been acquired within the timeout time T_th, the acquired recognition result is determined as a recognition result of the speech recognition process. In a case where there are a plurality of recognition results that have been acquired, a recognition result acquired by integrating the recognition results, for example, using known technologies of Non Patent Literature 1 and the like is determined as a recognition result of the speech recognition process.

### Second Embodiment

The speech recognition control device according to the first embodiment controls the timeout time for waiting for a recognition result; however, a speech recognition control device according to a second embodiment performs control of search process parameters of speech recognition in addition thereto.

When a request for a speech recognition process is transmitted to each of a speech recognition unit 13 and a speech recognition device 2, a speech recognition requesting unit 12 according to the second embodiment also performs control of search process parameters of speech recognition in accordance with an immediately prior communication state. For example, in a case where a delay time is long as in the case of RTT_b>RTT_ave+2*RTT_sd, the search process parameters of the speech recognition are limited. In accordance with this, a time required for speech recognition can be reduced, and a time until the acquisition of a recognition result can be shortened. As regards the search parameters, for example, narrowing the beam width when searching leads to a reduction in processing time. On the other hand, in a case where a sufficient communication speed is expected as in the case of RTT_b≤RTT_ave−2*RTT_sd, the search process parameters may be adjusted in a direction in which recognition accuracy is increased. As regards the search processing parameters, for example, widening the beam width when searching leads to an improvement in recognition accuracy.

### Third Embodiment

The speech recognition control devices according to the first embodiment and the second embodiment control a timeout process for a time required until acquisition of a recognition result as a target; however, a speech recognition control device according to a third embodiment performs control on a threshold process using a reliability scale as a target.

When a request for a speech recognition process is transmitted to each of a speech recognition unit 13 and a speech recognition device 2, a speech recognition requesting unit 12 according to the third embodiment sets a threshold of a reliability scale in accordance with an immediately prior communication state. In a case where a reliability scale of a recognition result acquired first from the speech recognition unit 13 or the speech recognition device 2 is higher than the set threshold, the recognition result is regarded as being sufficiently reliable, and thus a recognition result output unit 14 according to the third embodiment returns the recognition result without waiting for another recognition result. On the other hand, in a case where a reliability scale of the acquired recognition result is lower than the threshold, a process of waiting for another recognition result is performed. Here, in a case where a delay time is long, there is a low likelihood of another recognition result being returned within the timeout time, and thus the threshold of the reliability scale is set to be low. On the other hand, in a case where the delay time is short, the threshold of the reliability scale is set to be high. For example, in a case where the delay time is long as in the case of RTT_b>RTT_ave+2*RTT_sd, the threshold of the reliability scale may be set to 0.5 or the like. In a case where the delay time is short as in the case of as RTT_b≤RTT_ave−2*RTT_sd, the threshold of the reliability scale may be set to 0.8 or the like.

Although the embodiments of the present invention have been described, a specific configuration is not limited to the embodiments, and appropriate changes in the design are, of course, included in the present invention within the scope of the present disclosure without departing from the gist of the present invention. The various steps of the processing described in the embodiments are not only executed sequentially in the described order but may also be executed in parallel or separately as necessary or in accordance with a processing capability of the device that performs the processing.

### Program and Recording Medium

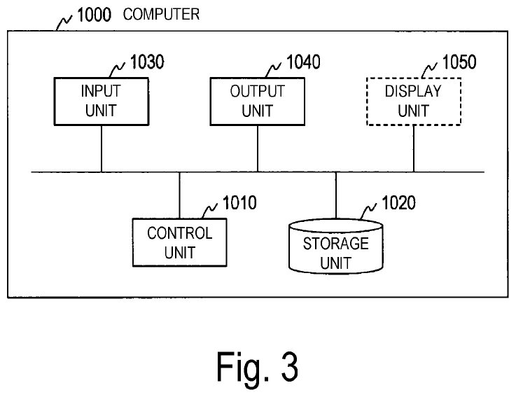

In a case where various processing functions in each device described in the foregoing embodiment are implemented by a computer, processing details of the functions that each device should have are described by a program. By causing this program to be read into a storage unit 1020 of the computer illustrated in FIG. 3 and causing a control unit 1010, an input unit 1030, an output unit 1040, and the like to operate, various processing functions of each of the devices described above are implemented on the computer.

The program in which the processing details are described can be recorded on a computer-readable recording medium. The computer-readable recording medium, for example, can be any type of medium such as a magnetic recording device, an optical disc, a magneto-optical recording medium, or a semiconductor memory.

The program is distributed, for example, by selling, giving, or lending a portable recording medium such as a DVD or a CD-ROM with the program recorded on it. Further, the program may be stored in a storage device of a server computer and transmitted from the server computer to another computer via a network, so that the program is distributed.

For example, a computer executing the program first temporarily stores the program recorded on the portable recording medium or the program transmitted from the server computer in the storage device of the computer. When processing is executed, the computer reads the program stored in its own storage device and executes processing in accordance with the read program. As another execution form of the program, the computer may directly read the program from the portable recording medium and execute processing in accordance with the program. Further, each time the program is transmitted from the server computer to the computer, the computer may execute processing sequentially in accordance with the received program. In another configuration, the processing may be executed through a so-called application service provider (ASP) service in which processing functions are implemented just by issuing an instruction to execute the program and obtaining results without transmission of the program from the server computer to the computer. The program in this form is assumed to include information provided for processing by a computer, the information being equivalent to a program (data or the like that has characteristics regulating processing of the computer rather than a direct instruction for a computer).

Also, in this form, the device is configured by executing a predetermined program on a computer. However, at least a part of the processing details may be implemented by hardware.

1. A speech recognition control device that acquires recognition results from a plurality of speech recognizers including at least one speech recognizer that performs communication through a network, the speech recognition control device comprising:
a communication state measurer configured to measure a communication state of the network;
a speech recognition requestor configured to transmit a request for a speech recognition process to each of the plurality of speech recognizers with a timeout time set in accordance with an immediately prior communication state of the network; and
a recognition result output generator configured to output a recognition result based on a recognition result received from at least one of the plurality of speech recognizers.

2. The speech recognition control device according to claim 1, wherein the speech recognition requestor sets a search parameter in accordance with the immediately prior communication state of the network and transmits the request for the speech recognition process.

3. The speech recognition control device according to claim 1,
wherein the speech recognition requestor transmits the request for the speech recognition process with a threshold of a reliability scale set in accordance with the immediately prior communication state of the network, and
when a reliability scale of a recognition result received from a certain speech recognizer among the plurality of speech recognizers exceeds the threshold, the recognition result output generator outputs the received recognition result without waiting for a recognition result of another of the plurality of speech recognizers.

4. A speech recognition control method for acquiring recognition results from a plurality of speech recognizers including at least one speech recognizer that performs communication through a network, the speech recognition control method comprising:
measuring, by a communication state measurer, a communication state of the network;
transmitting, by a speech recognition requestor, a request for a speech recognition process to each of the plurality of speech recognizers with a timeout time set in accordance with an immediately prior communication state of the network; and
outputting, by a recognition result output generator, a recognition result based on a recognition result received from at least one of the plurality of speech recognizers.

5. A computer-readable non-transitory recording medium storing computer-executable program instructions that when executed by a processor cause a computer system to perform a method comprising:
measuring, by a communication state measurer, a communication state of a network;
transmitting, by a speech recognition requestor, a request for a speech recognition process to each of a plurality of speech recognizers with a timeout time set in accordance with an immediately prior communication state of the network; and
outputting, by a recognition result output generator, a recognition result based on a recognition result received from at least one of the plurality of speech recognizers.

6. The speech recognition control device according to claim 1, wherein the immediately prior communication state of the network is based on a round-trip time of a communication measured over the network and an average round-trip time of a communication during non-network congestion.

7. The speech recognition control device according to claim 2, wherein the search parameter includes a beam width of a search.

8. The speech recognition control device according to claim 2,
wherein the speech recognition requestor transmits the request for the speech recognition process with a threshold of a reliability scale set in accordance with the immediately prior communication state of the network, and
when a reliability scale of a recognition result received from a certain speech recognizer among the plurality of speech recognizers exceeds the threshold, the recognition result output generator outputs the received recognition result without waiting for a recognition result of another of the plurality of speech recognizers.

9. The speech recognition control device according to claim 3, wherein the reliability scale represents a degree of reliability of the recognition result.

10. The speech recognition control method according to claim 4, wherein the speech recognition requestor sets a search parameter in accordance with the immediately prior communication state of the network and transmits the request for the speech recognition process.

11. The speech recognition control method according to claim 4,
wherein the speech recognition requestor transmits the request for the speech recognition process with a threshold of a reliability scale set in accordance with the immediately prior communication state of the network, and
when a reliability scale of a recognition result received from a certain speech recognizer among the plurality of speech recognizers exceeds the threshold, the recognition result output generator outputs the received recognition result without waiting for a recognition result of another of the plurality of speech recognizers.

12. The speech recognition control method according to claim 4, wherein the immediately prior communication state of the network is based on a round-trip time of a communication measured over the network and an average round-trip time of a communication during non-network congestion.

13. The speech recognition control method according to claim 10, wherein the search parameter includes a beam width of a search.

14. The speech recognition control method according to claim 10,
wherein the speech recognition requestor transmits the request for the speech recognition process with a threshold of a reliability scale set in accordance with the immediately prior communication state of the network, and
when a reliability scale of a recognition result received from a certain speech recognizer among the plurality of speech recognizers exceeds the threshold, the recognition result output generator outputs the received recognition result without waiting for a recognition result of another of the plurality of speech recognizers.

15. The speech recognition control method according to claim 11, wherein the reliability scale represents a degree of reliability of the recognition result.

16. The computer-readable non-transitory recording medium according to claim 5, wherein the speech recognition requestor sets a search parameter in accordance with the immediately prior communication state of the network and transmits the request for the speech recognition process.

17. The computer-readable non-transitory recording medium according to claim 5, wherein the speech recognition requestor transmits the request for the speech recognition process with a threshold of a reliability scale set in accordance with the immediately prior communication state of the network, and
when a reliability scale of a recognition result received from a certain speech recognizer among the plurality of speech recognizers exceeds the threshold, the recognition result output generator outputs the received recognition result without waiting for a recognition result of another of the plurality of speech recognizers.

18. The computer-readable non-transitory recording medium according to claim 5, wherein the immediately prior communication state of the network is based on a round-trip time of a communication measured over the network and an average round-trip time of a communication during non-network congestion.

19. The computer-readable non-transitory recording medium according to claim 16, wherein the search parameter includes a beam width of a search.

20. The computer-readable non-transitory recording medium according to claim 17, wherein the reliability scale represents a degree of reliability of the recognition result.
